(19) United States
(12) Patent Application Publication
(10) Pub. No.: US 2013/0124135 A1
(43) Pub. Date: May 16, 2013

(54) COMPUTING DEVICE AND METHOD FOR AUTOMATICALLY REPLACING PROBES FOR COORDINATE MEASURING MACHINES

(71) Applicants: CHIH-KUANG CHANG, Tu-Cheng (TW); ZHONG-KUI YUAN, Shenzhen City (CN); ZHENG-CAI SHE, Shenzhen City (CN); YU-HUA XU, Shenzhen City (CN); XIAO-GUANG XUE, Shenzhen City (CN)

(72) Inventors: CHIH-KUANG CHANG, Tu-Cheng (TW); ZHONG-KUI YUAN, Shenzhen City (CN); ZHENG-CAI SHE, Shenzhen City (CN); YU-HUA XU, Shenzhen City (CN); XIAO-GUANG XUE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/545,156

(22) Filed: Jul. 10, 2012

(30) Foreign Application Priority Data
Nov. 14, 2011 (CN) 201110359056.2

(51) Int. Cl. G06F 19/00

(52) U.S. Cl. 702/121

(57) ABSTRACT

In a computing device, computerized method, and a non-transitory storage medium, correction data of a probe holder is read. The probe holder comprises one or more slots that houses all available probes and is placed on the coordinate measuring machine. The correction data comprises coordinates of the slots. A coordinate of one of the slots is obtained from the correction data. A Z-axis of the coordinate measuring machine moves to a position that corresponds to the extracted coordinates, to detach a probe which is currently installed on the Z-axis and to place the detached probe into the slot, and/or to pick up and install another probe which is currently housed in the slot onto the Z-axis.

### BACKGROUND

1. Technical Field

Embodiments of the present disclosure relate to measuring field, and more particularly to a computing device and a method for automatically replacing probes for coordinate measuring machines.

2. Description of Related Art

Coordinate measuring machines (CMMs) are mechanical systems designed to move a measuring probe (probe, hereinafter for short) to determine coordinates of points on an object surface. CMMs provide precise measurements of objects for design, testing, assessment, and profiling.

CMMs are comprised of three main components: the machine itself, a probe, and a control or computing system with appropriate measuring software. After placing an object on a machine table of the CMM, the probe of the CMM is used to measure different points on the object. The probe operates either manually via an operator or automatically via the control or computing system.

Sometimes, the probe of one type installed on the CMM may need to be replaced by a probe of a different type for measuring different parts of the object. Usually, such a replacement of the probe on a CMM needs to be done by a measuring engineer manually. It is time-consuming and troublesome for the measuring engineer to manually replace the probe.

### BRIEF DESCRIPTION OF THE DRAWINGS

FIG. 1 is a block diagram of one embodiment of a computing device having a probe replacement system.

FIG. 2 is a block diagram of one embodiment of function modules of the probe replacement system in FIG. 1.

FIG. 3 is a flowchart illustrating one embodiment of a method for automatically replacing probes for coordinate measuring machines.

FIGS. 4A and 4B are flowcharts detailing step S11 of FIG. 3.

### DETAILED DESCRIPTION

In general, the word “module,” as used hereinafter, refers to logic embodied in hardware or firmware, or to a collection of software instructions, written in a programming language, such as, for example, Java, C, or assembly language. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

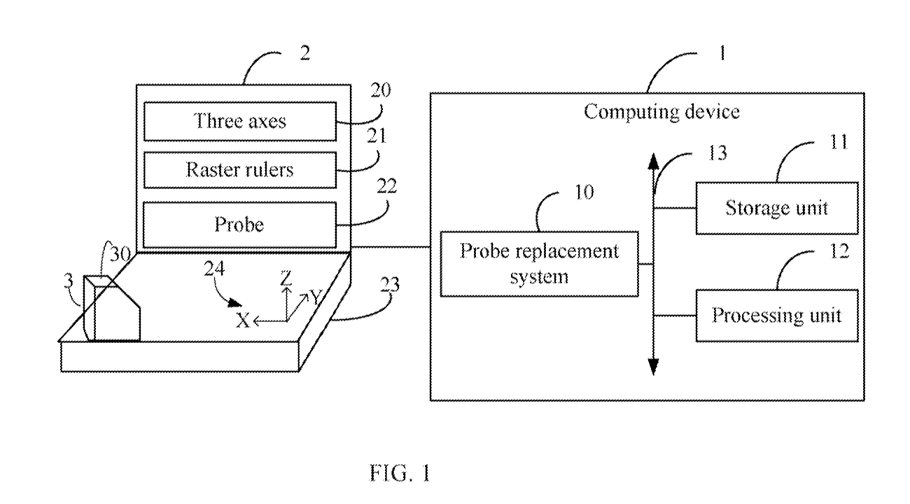

FIG. 1 is a block diagram of one embodiment of a computing device 1 including a probe replacement system 10. The computing device 1 may be a computer, a server, or a personal digital assistant (PDA), for example. The computing device 1 may further include components such as a storage unit 11, a processing unit 12, and a bus 13. The computing device 1 may be configured in a number of other ways and may include other or different components or have components arranged in different ways.

The computing device 1 communicates with a coordinate measuring machine 2. The coordinate measuring machine 2 includes three axes 20, each of which is installed with a raster ruler 21. The three axes 20 are movable and include an X-axis, a Y-axis, and a Z-axis. In addition, a probe 22 may be fixed at the Z-axis. The raster ruler 21 is a position feedback component, which may be a magnetoscale ruler or a rotary encoder. When the probe 22 contacts a point on an object surface, the raster rulers 21 return a feedback pulse to determine current coordinates of the point.

The coordinate measuring machine 2 further includes a machine table 23. In one embodiment, a probe holder 3 is placed on the machine table 23. The probe holder 3 includes a plurality of slots 30, each of which can be used to house a probe, such as the probe 22. The probes 22 placed in different slots 30 may be different types.

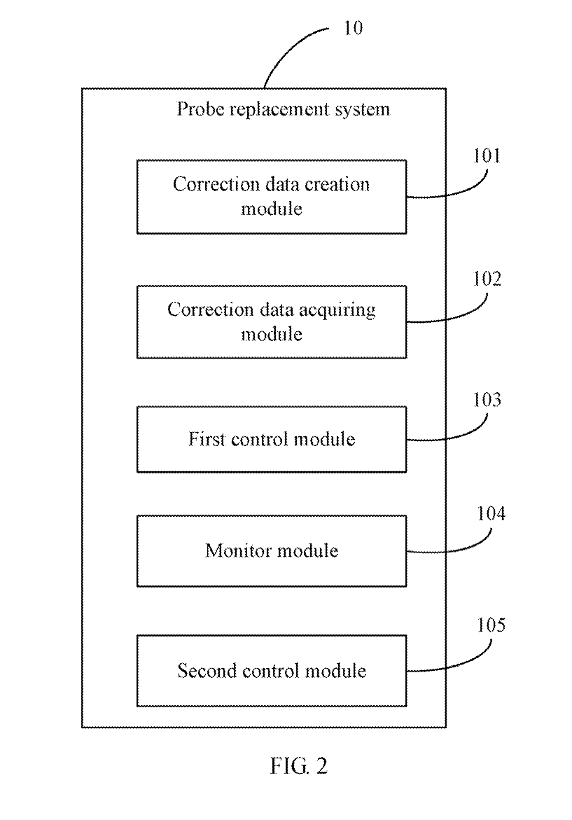

The probe replacing system 10 in the computing device 1 includes a number of function modules (depicted in FIG. 2). The function modules may include computerized codes in the form of one or more programs, which have functions of automatically replacing the probe 22 for the coordinate measuring machine 2, namely detaching the probe 22 from the coordinate measuring machine 2 to the slots 30, and/or installing a different type of probe 22 from one of the slots 30 to the coordinate measuring machine 2.

The storage unit 11 may include some type(s) of non-transitory computer-readable storage medium, such as a hard disk drive, a compact disc, a digital video disc, or a tape drive. The storage unit 11 stores the computerized code of the function modules of the probe replacing system 10. Furthermore, the storage unit 11 may store basic data of the probe placement frame 3. In one embodiment, the basic data may include size data of the probe placement frame 3 and location data of each slot 30 of the probe placement frame 3.

The processing unit 12 may include a processor, a microprocessor, an application-specific integrated circuit (ASIC), or a field programmable gate array, (FPGA) for example. The processing unit 12 may execute the computerized codes of the function modules of the probe replacement system 10 to realize the aforementioned functions of the probe replacing system 10.

The bus 13 permits communication among the components, such as the probe replacement system 10, the storage unit 11, and the processing unit 12.

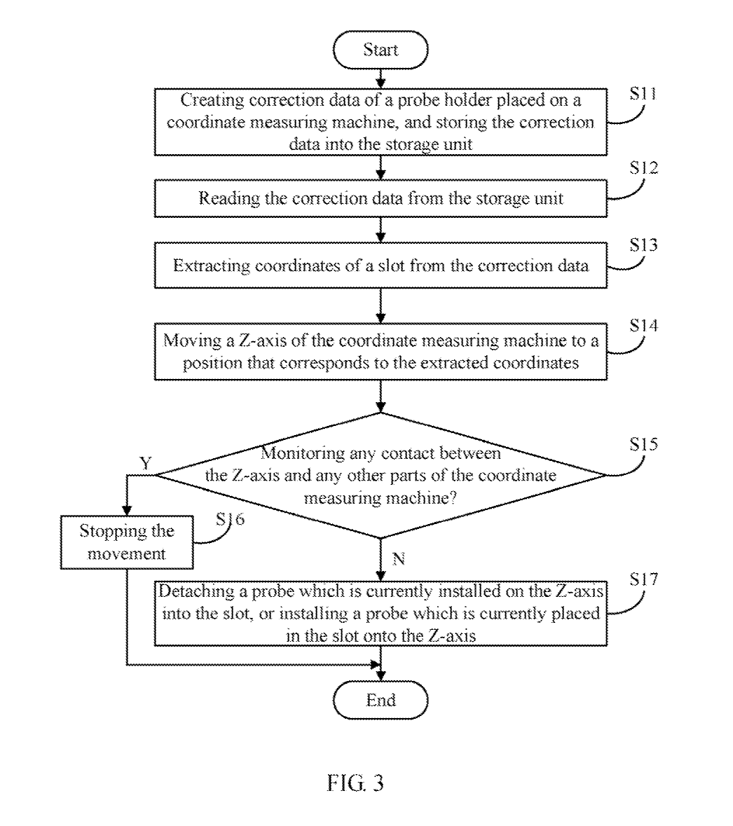

FIG. 2 is a block diagram of one embodiment of function modules of the probe replacement system 10. In one embodiment, the probe replacement system 10 may include a correction data creation module 101, a correction data acquiring module 102, a first control module 103, a monitor module 104, and a second control module 105. The function modules 101 to 105 provide at least the functions needed to execute the steps illustrated in FIG. 3.

FIG. 3 is a flowchart illustrating one embodiment of a method for automatically replacing probes for coordinate measuring machines. Depending on the embodiment, additional steps in FIG. 3 may be added, others removed, and the ordering of the steps may be changed.

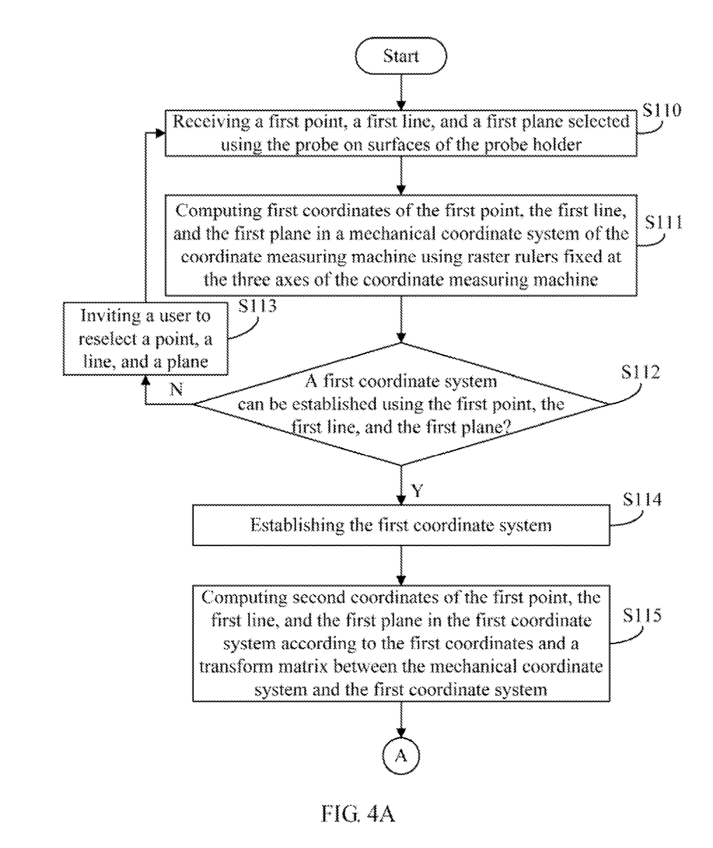

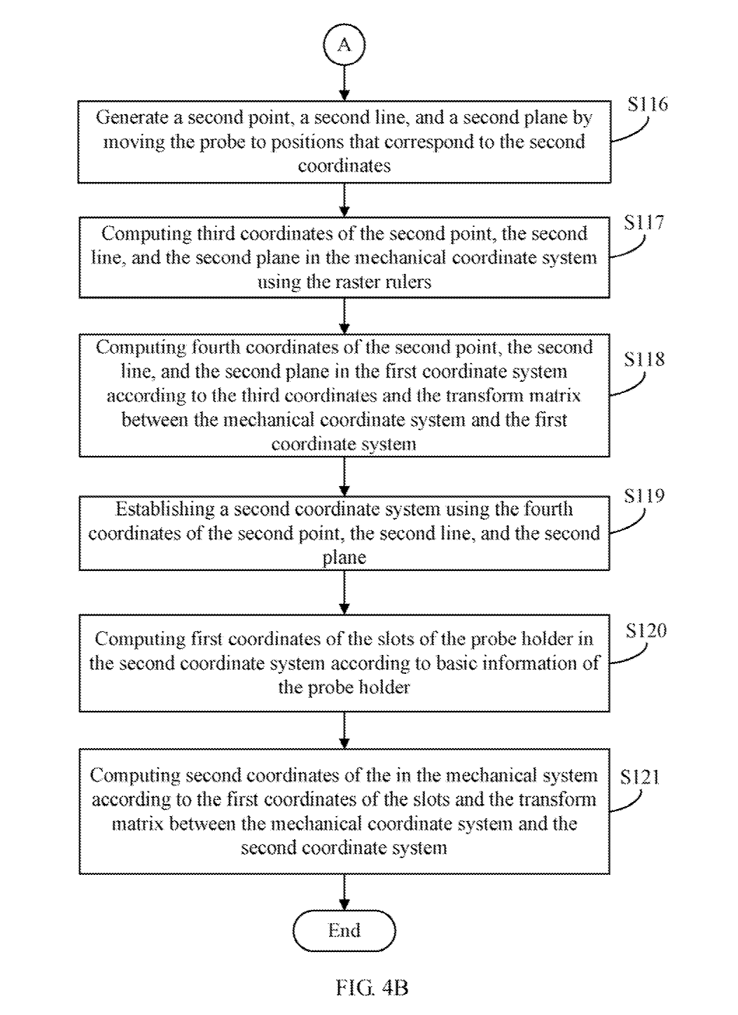

In step S11, the correction data creation module 101 creates correction data of the probe placement frame 3 which is placed on the machine table 23 of the coordinate measuring machine 2, and stores the correction data into the storage unit 11 of the computing device 1. In one embodiment, the correction data includes coordinates of all the slots 30 of the probe holder 3, in a mechanical coordinate system 24 of the coordinate measuring machine. A detailed description of how to create the correction data is illustrated in FIGS. 4A and 4B.

In step S12, the correction data acquiring module 102 reads the correction data of the probe holder 3 from the storage unit 11.

In step S13, the correction data acquiring module 102 extracts coordinates of a selected slot 30 of the probe holder 3 from the correction data, where the selected slot 30 is to be used as the housing of the probe 22 which is currently installed on the coordinate measuring machine 2, or as the source of another probe 22 which is to be installed to the coordinate measuring machine 2.

In step S14, the first control module 103 moves the Z-axis of the coordinate measuring machine 2 to a position that corresponds to the extracted coordinates. That is, the first control module 103 moves the Z-axis of the coordinate measuring machine 2 to the selected slot 30.

In step S15, the monitor module 104 monitors the occurrence of any contact between the Z-axis and any other part of the coordinate measuring machine 2. In one embodiment, when such a contact occurs, an electronic signal may be generated. Thus, the monitor module 104 may determine if there is such a contact according to the generated electronic signal.

When such a contact occurs, step S16 is implemented, in which, the movement of the Z-axis is controlled to be stopped. Otherwise, if no such contact occurs step S17 is implemented.

In step S17, the second control module 105 detaches the probe 22 which is currently installed on the Z-axis of the coordinate measuring machine 2 and places the detached probe 22 into the selected slot 30, and/or installs the probe 22 which is housed in the selected slot 30 onto the Z-axis of the coordinate measuring machine 2. It may be understood that, when there is a probe 22 installed on the Z-axis, the second control module 105 detaches the probe 22 from the Z-axis, and places the detached probe 22 into the selected slot 30. In another embodiment, where there is not any probe 22 installed on the Z-axis, the second control module 105 can install the probe 22 which is housed in the selected slot 30 onto the Z-axis of the coordinate measuring machine 2.

FIGS. 4A and 4B are flowcharts detailing step S11 of FIG. 3. Depending on the embodiment, additional steps in FIGS. 4A and 4B may be added, others removed, and the ordering of the steps may be changed.

In step S110, the correction data creation module 101 receives a first point, a first line, and a first plane selected using the probe 22 on surfaces of the probe placement frame 3.

In step S111, the correction data creation module 101 computes first coordinates of the first point, the first line, and the first plane in the mechanical coordinate system 24 of the coordinate measuring machine 2 using the raster rulers 21 that are fixed at the three axes 20 of the coordinate measuring machine 2. As mentioned above, when the probe 21 contacts a point on an object surface, the raster rulers 22 returns a feedback pulse to determine coordinates of the point.

In step S112, the correction data creation module 101 determines if a first coordinate system can be established using the first point, the first line, and the first plane. In one embodiment, if the first line is perpendicular to the first plane, the correction data creation module 101 determines that the first coordinate system cannot be established, and step S113 is implemented.

In step S113, the correction data creation module 101 invites a user to reselect a different point, a different line, and a different plane on the surfaces of the probe placement frame 3. After step S113, the flow goes back to step S110. If the first coordinate system can be established, step S114 is implemented.

In step S114, the correction data creation module 101 establishes the first coordinate system by taking the first point as an origin, taking the first line as an X-axis, and taking the first plane as an XY plane.

In step S115, the correction data creation module 101 computes second coordinates of the first point, the first line, and the first plane, in the first coordinate system according to the first coordinates and a transform matrix between the mechanical coordinate system 24 and the first coordinate system.

In step S116, the correction data creation module 101 generates a second point, a second line, and a second plane by moving the probe 22 to positions that correspond to the second coordinates of the first point, the first line, and the first plane.

In step S117, the correction data creation module 101 computes third coordinates of the second point, the second line, and the second plane in the mechanical coordinate system 24 using the raster rulers 21.

In step S118, the correction data creation module 101 computes fourth coordinates of the second point, the second line, and the second plane in the first coordinate system according to the third coordinates and the transform matrix between the mechanical coordinate system 24 and the first coordinate system.

In step S119, the correction data creation module 101 establishes a second coordinate system using the fourth coordinates by taking the second point as an origin, taking the second line as an X-axis, and taking the second plane as an XY plane.

In step S120, the correction data creation module 101 computes first coordinates of the slots 30 in the second coordinate system according to the basic data of the probe placement frame 3 that is stored in the storage unit 11. As mentioned above, the basic data may include size data of the probe placement frame 3 and location data of each slot 30 of the probe placement frame 3.

In step S121, the correction data creation module 101 computes second coordinates of the slots 30 in the mechanical coordinate system 24 according to the first coordinates of the slots 30 and a transform matrix between the mechanical coordinate system 24 and the second coordinate system. It is the second coordinates of the slots 30 which are the correction data of the probe placement frame 3.

The above-described embodiments of the present disclosure, including any particular embodiments, are merely possible examples of implementations, set forth for a clear understanding of the principles of the disclosure. Many variations and modifications may be made to the above embodiment(s) of the disclosure without departing substantially from the spirit and principles of the disclosure. All such modifications and variations are intended to be included herein within the scope of this disclosure and the present disclosure is protected by the following claims.

What is claimed is:

1. A computerized method for automatically replacing probes for a coordinate measuring machine, the method being executed by at least one processor of a computing device and comprising:
reading correction data of a probe holder, which comprises one or more slots that house probes and is placed on the coordinate measuring machine, wherein the correction data comprises coordinates of the slots;
extracting coordinates of one of the slots from the correction data;
moving a Z-axis of the coordinate measuring machine to a position that corresponds to the extracted coordinates; and
detaching a probe which is currently installed on the Z-axis and placing the detached probe into a slot, or installing the probe which is currently housed in the slot onto the Z-axis.

2. The method according to claim 1, during movement of the Z-axis, the method further comprising:
monitoring any contact between the Z-axis and any other parts of the coordinate measuring machine; and
stopping the movement of the Z-axis when any contact between the Z-axis and any other parts of the coordinate measuring machine occurs.

3. The method according to claim 1, before the reading step, the method further comprising:
creating the correction data of the probe placement frame, and storing the correction data into a storage unit of the computing device.

4. The method according to claim 3, wherein the creating step comprises:
receiving a first point, a first line, and a first plane, selected using the probe installed on the Z-axis, on surfaces of the probe placement frame;
computing first coordinates of the first point, the first line, and the first plane in a mechanical coordinate system of the coordinate measuring machine using raster rulers that are fixed at three axes of the coordinate measuring machine;
establishing a first coordinate system using the first point, the first line, and the first plane;
computing second coordinates of the first point, the first line, and the first plane in the first coordinate system according to the first coordinates and a transform matrix between the mechanical coordinate system and the first coordinate system;
generating a second point, a second line, and a second plane by moving the probe to positions that corresponds to the second coordinates of the first point, the first line, and the first plane;
computing third coordinates of the second point, the second line, and the second plane in the mechanical coordinate system using the raster rulers, and computing fourth coordinates of the second point, the second line, and the second plane in the first coordinate system according to the third coordinates and the transform matrix between the mechanical coordinate system and the first coordinate system;
establishing a second coordinate system using the fourth coordinates of the second point, the second line, and the second plane;
computing first coordinates of the slots in the second coordinate system according to basic data of the probe placement frame; and
computing second coordinates of the slots in the mechanical coordinate system according to the first coordinates of the slots and a transform matrix between the mechanical coordinate system and the second coordinate system, wherein the second coordinates of the slots are the correction data of the probe placement frame.

5. The method according to claim 4, after the step of computing first coordinates of the first point, the first line, and the first plane and before the step of establishing a first coordinate system, the method further comprising:
determining if the first coordinate system can be established by determining if the first line is perpendicular to the first plane.

6. The method according to claim 4, wherein the first coordinate system is established by taking the first point as an origin, taking the first line as an X-axis, and taking the first plane as an XY plane.

7. An computing device, comprising:
a non-transitory storage medium;
at least one processor; and
one or more modules that are stored in the non-transitory storage medium; and are executed by the at least one processor, the one or more modules comprising instructions to:
read correction data of a probe holder which comprises one or more slots that house probes and is placed on the coordinate measuring machine, wherein the correction data comprises coordinates of the slots;
extract coordinates of one of the slots from the correction data;
move a Z-axis of the coordinate measuring machine to a position that corresponds to the extracted coordinates; and
detaching a probe which is currently installed on the Z-axis and placing the detached probe into the slot, or installing the probe which is currently housed in the slot onto the Z-axis.

8. The computing device according to claim 7, wherein the one or more modules further comprising instructions to:
monitor any contact between the Z-axis and any other parts of the coordinate measuring machine; and
stop the movement of the Z-axis when any contact between the Z-axis and any other parts of the coordinate measuring machine occurs.

9. The computing device according to claim 7, wherein the one or more modules further comprising instructions to:
create the correction data of the probe placement frame, and store the correction data into the non-transitory storage medium.

10. The computing device according to claim 9, wherein the correction data is created by:
receiving a first point, a first line, and a first plane selected using the probe installed on the Z-axis on surfaces of the probe placement frame;
computing first coordinates of the first point, the first line, and the first plane in a mechanical coordinate system of the coordinate measuring machine using raster rulers that are fixed at three axes of the coordinate measuring machine;
establishing a first coordinate system using the first point, the first line, and the first plane;
computing second coordinates of the first point, the first line, and the first plane in the first coordinate system according to the first coordinates and a transform matrix between the mechanical coordinate system and the first coordinate system;
generating a second point, a second line, and a second plane by moving the probe to positions that correspond to the second coordinates of the first point, the first line, and the first plane in turn;
computing third coordinates of the second point, the second line, and the second plane, in the mechanical coordinate system using the raster rulers, and computing fourth coordinates of the second point, the second line, and the second plane in the first coordinate system according to the third coordinates and the transform matrix between the mechanical coordinate system and the first coordinate system;
establishing a second coordinate system using the fourth coordinates of the second point, the second line, and the second plane;
computing first coordinates of the slots in the second coordinate system according to basic data of the probe placement frame; and
computing second coordinates of the slots in the mechanical coordinate system according to the first coordinates of the slots and a transform matrix between the mechanical coordinate system and the second coordinate system, wherein the second coordinates of the slots are the correction data of the probe placement frame.

11. The computing device according to claim 10, wherein before establishing the first coordinate system, a determination of if the first line is perpendicular to the first plane is made.

12. The computing device according to claim 10, wherein the first coordinate system is established by taking the first point as an origin, taking the first line as an X-axis, and taking the first plane as an XY plane.

13. A non-transitory storage medium having stored thereon instructions that, when executed by a processor of a computing device, causes the processor to perform a method for automatically replacing probes for a coordinate measuring machine, wherein the method comprises:
reading correction data of a probe holder which comprises one or more slots that house probes and is placed on the coordinate measuring machine, wherein the correction data comprises coordinates of the slots;
extracting coordinates of one of the slots from the correction data;
moving a Z-axis of the coordinate measuring machine to a position that corresponds to the extracted coordinates; and
detaching a probe which is currently installed on the Z-axis and placing the detached probe into the slot, or installing the probe which is currently housed in the slot onto the Z-axis.

14. The non-transitory storage medium according to claim 13, wherein the method further comprises:
monitoring any contact between the Z-axis and any other parts of the coordinate measuring machine during movement of the Z-axis; and
stopping the movement of the Z-axis when any contact between the Z-axis and any other parts of the coordinate measuring machine occurs.

15. The non-transitory storage medium according to claim 13, wherein the method further comprises:
creating the correction data of the probe placement frame, and storing the correction data into a storage unit of the computing device before the reading step.

16. The non-transitory storage medium according to claim 15, wherein the creating step comprises:
receiving a first point, a first line, and a first plane selected using the probe installed on the Z-axis on surfaces of the probe placement frame;
computing first coordinates of the first point, the first line, and the first plane in a mechanical coordinate system of the coordinate measuring machine using raster rulers that are fixed at three axes of the coordinate measuring machine;
establishing a first coordinate system using the first point, the first line, and the first plane;
computing second coordinates of the first point, the first line, and the first plane in the first coordinate system according to the first coordinates and a transform matrix between the mechanical coordinate system and the first coordinate system;
generating a second point, a second line, and a second plane by moving the probe to positions that correspond to the second coordinates of the first point, the first line, and the first plane in turn;
computing third coordinates of the second point, the second line, and the second plane in the mechanical coordinate system using the raster rulers, and computing fourth coordinates of the second point, the second line, and the second plane in the first coordinate system according to the third coordinates and the transform matrix between the mechanical coordinate system and the first coordinate system;
establishing a second coordinate system using the fourth coordinates of the second point, the second line, and the second plane;
computing first coordinates of the slots in the second coordinate system according to basic data of the probe placement frame; and
computing second coordinates of the slots in the mechanical coordinate system according to the first coordinates of the slots and a transform matrix between the mechanical coordinate system and the second coordinate system, wherein the second coordinates of the slots are the correction data of the probe placement frame.

17. The non-transitory storage medium according to claim 16, wherein before the step of establishing a first coordinate system, the method further comprises:
determining if the first coordinate system can be established by determining if the first line is perpendicular to the first plane.

18. The non-transitory storage medium according to claim 16, wherein the first coordinate system is established by taking the first point as an origin, taking the first line as an X-axis, and taking the first plane as an XY plane.
